(19) United States
(12) Patent Application Publication
(10) Pub. No.: US 2025/0371735 A1
(43) Pub. Date: Dec. 4, 2025

(54) BALL LOCATING IN IMAGES OF SPORTS GAMES

(71) Applicant: ESK Gaming LTD, Tel Aviv (IL)

(72) Inventors: Kfir SHEINFELD, Tel Aviv (IL); Royi Avital, Holon (IL)

(73) Assignee: ESK Gaming LTD, Tel Aviv (IL)

(21) Appl. No.: 18/733,526

(22) Filed: Jun. 4, 2024

(51) Int. Cl. G06T 7/73; G06V 10/26; G06V 10/764

(52) U.S. Cl. CPC G06T 7/73; G06T 2207/10016; G06T 2207/20084; G06T 2207/30224; G06T 2207/30228; G06V 10/26; G06V 10/764; G06V 2201/07

(57) ABSTRACT

Systems and methods for determining a ball position with respect to a real-world playing field from a captured image of the ball in the real-world playing field are disclosed. Systems and methods may include: identifying at least one of playing field lines and playing field markers in a captured image; extracting a set of points in the captured image having corresponding known locations in a real-world playing field; determining an estimate for a mathematical transformation that transforms a given position in the captured image to a corresponding position on the real-world playing field by using a regression analysis; refining the mathematical transformation based on at least one known property of the real-world playing field; detecting a ball within the captured image; and transforming, using the mathematical transformation, a position of the ball in the captured image to determine a ball position relative to the real-world playing field.

### FIELD OF THE INVENTION

The present invention relates generally to finding a real-world position of an object from an image of the object within some surroundings. The invention may be particularly relevant to usage of accurately and precisely locating a ball in sports video footage.

### BACKGROUND OF THE INVENTION

In the fields of sports and sports broadcasting, it may be desired to determine the positions of elements on a playing field at certain points during a sports game, from video footage or images taken of the sports game. It may be desired to determine the positions of elements in real-time. It may be desired to determine the positions of elements to a high degree of accuracy. It may be desired to determine the position of a ball in a sports game, such as soccer. It may be difficult to determine the positions of elements from video footage or images, since the video footage or images may have one or more unknown parameters, for example, an unknown perspective, magnification, angle, distance, distortion, and/or lens.

Existing methods and systems for determining positions of elements on a playing field at certain points during a sports game may not be able to locate balls in a playing field in a manner that is accurate, computationally efficient, and/or computationally fast enough for a number of implementations, such as gambling, sports analytics, sports coaching, research, gaming, virtual reality, and/or others. Other difficulties with current systems and methods are that they may fail to account for image irregularities, which may include an unknown perspective, magnification, angle, distance, distortion, and/or lens.

### SUMMARY OF THE INVENTION

Advantages of the invention can include improved accuracy, efficiency, and/or computational speed when determining positions of elements on a playing field during a sports game. Transformations or homographies may be calculated as described further below for finding real-world positions from positions in an image of the real world. Advantages of the invention can include determining the transformations accurately, efficiently, and/or quickly. In the context of sports and playing fields, specific knowledge of a playing field's dimensions may be used to improve or fine-tune the accuracy of transformations according to embodiments herein. Embodiments herein may provide for accurately, efficiently, and/or quickly locating balls on recorded images of the playing field.

Systems and methods for determining a ball position with respect to a real-world playing field from a captured image of the ball in the real-world playing field are disclosed. Systems and methods may include: identifying at least one of playing field lines and playing field markers in a captured image; extracting a set of points in the captured image having corresponding known locations in a real-world playing field; determining an estimate for a mathematical transformation that transforms a given position in the captured image to a corresponding position on the real-world playing field by using a regression analysis; refining the mathematical transformation based on at least one known property of the real-world playing field; detecting a ball within the captured image; and transforming, using the mathematical transformation, a position of the ball in the captured image to determine a ball position relative to the real-world playing field. One or more operations may utilize one or more neural networks.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 shows a flowchart for determining a ball position with respect to a real-world playing field according to some embodiments of the invention.

FIG. 2 shows a flowchart for determining a ball position with respect to a real-world playing field according to some embodiments of the invention.

FIGS. 3A and 3B show a captured image of a real-world playing field and a number of lines that may be recognized therein.

FIGS. 4A, 4B, and 4C show playing field lines in a captured image and in their corresponding known locations in a real-world playing field.

FIG. 5 shows the extraction of a position of a ball in a captured image.

FIG. 6 shows a block diagram of an exemplary computing device which may be used with embodiments of the present invention.

### DETAILED DESCRIPTION OF THE INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input training data, such as video footage of a sports game, may be labelled (e.g., using metadata) to indicate the position of lines, markers, a ball, or similar. In an unsupervised ML approach, the input sample data may not include any labels, for example, in the present application, the input training data may include video footage of a sports game only.

ML models may, for example, include (artificial) neural networks (NN), decision trees, regression analysis, Bayesian networks, Gaussian networks, genetic processes, etc. In some embodiments, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links, or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs may be particularly useful for visual applications. Other NNs can include for example transformer NNs, which may be useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as, for example, a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

Where “neural network” is referred to subsequently, it will be understood that, while a neural network may form an embodiment, it may be possible to implement a method to be carried out by a neural network using another type of machine learning model, for example, as described herein.

As used herein, “playing field”, “sports ground”, “pitch”, or “field” may refer to some physical area in which in which a sport or game takes place, including ball sports and ball games. It need not literally include a field, for example, ice hockey may take place on an ice rink. A playing field may have dimensions that are regulated, known, measured, stored, and/or recorded, for example, in terms of length and width. Different areas or parts of a playing field may have different rules that relate to that area or part, for example, in soccer, there are a number of rules that apply only in a penalty area in the vicinity of a goal. A playing field, its dimensions, parts, areas, and/or points, and/or divisions thereof may be marked or demarcated using “lines” or “markers”. Lines or markers may be painted, marked, and/or adhered to a playing field. Lines and markers may be of a different color to the playing field, for example, on a green grass football field, lines and markers may be a white color. Lines may mark a certain length or boundary, whereas markers may mark a certain point (e.g., with a circle or X shape). Lines may be defined by two end points or coordinates. Markers may be defined by a central point or coordinate.

Lines that are visible on a playing field may be referred herein as “actual lines”. Actual lines may be “extrapolated”, e.g., by a computing device, to obtain “extrapolated lines”, which may, according to some embodiments, only exist on a computing device. An extrapolated line can be an assessment of where, in the real world or in an image, the actual line would be positioned if it did not end at a certain end point and was extended. Extrapolated lines may be used in some analyses of a playing field or image. For example, a point may be defined on a computing device as a point where an extrapolated line intersects (or would intersect) with an actual line, and this point may be used in analyses herein. “Virtual lines” may be any lines that are constructed, for example, on a computing device, as passing through a number of markers or points (virtual lines may have no visible real-world equivalent). Virtual lines may be used in some analyses of a playing field or image. For example, in soccer, a virtual line may be defined or constructed between a penalty marker and a penalty box corner, and this line (e.g., its properties, such as length) may be used in analyses herein.

A point (or coordinate or location) herein may be expressed in two dimensions, for example, when referring to an image (e.g., width and height from an origin point) or when referring to a surface of a playing field (e.g., width and length from an origin point). A point may be expressed in three dimensions, for example, when referring to a physical space including the playing field and a volume or 3D space above the playing field (e.g., a third dimension may be a height above the playing field, e.g., with respect to an origin point or the surface). Some points may be “actual points”, e.g., defined by an intersection or corner of two actual lines or defined by a location of a marker. Some points may be “virtual points”, e.g., defined at least in part by at least one extrapolated or virtual line (e.g., a point where an extrapolated line intersects with an actual line). Actual points and virtual points may be used in some analyses of a playing field or image (e.g., a regression analysis).

As used herein, playing field “properties” may refer to any known property, dimension, length, area, ratio, or alignment of features of the (real-world) playing field or defined by markers, lines (actual, extrapolated, or virtual), or points (actual or virtual) thereof. For example, the following properties may be known: a line length (e.g., in units of length), a length between two points (e.g., in units of length), a ratio of lengths, an area of the playing field or area contained within a number of lines or points (e.g., in units of area), a ratio of areas, the fact that a number of points lie along a line, the fact that the line is an edge of a rectangle, the fact that the line is an edge of an ellipse or circle, etc. Properties may be used herein during “fine tuning”, in other words, to improve calculations herein. During fine tuning it may be assessed whether mathematical transformations herein replicate properties that are known about a playing field. Properties may be stored on a computing device, for example, using a data object or array.

The properties may relate to all playing fields for a given sport, or to a particular playing field, e.g., in a particular location. For example, in American football, playing fields may conform to standard dimensions of length 120 yards and width 160 feet. Whereas, by way of another example, in association football/soccer, playing fields may conform to a range of permitted dimension values of length 100-130 yards and width 50-100 yards. Given this, if a sport used in the invention herein is, for example, association football, it may be required to use a computer storage, database, or similar, to find dimension values for a specific playing field of which an image is taken, or it may be required that dimension values are received as an input.

Mathematical transformations (or mappings) herein may be expressed in any number of different ways, for example, as a matrix, as an algorithm, in functional notation, in index notation, etc. For conversion between one coordinate in X dimensions and another coordinate in Y dimensions, it may be possible or preferable to use a Y×X size matrix, wherein a vector matrix multiplication may transform one coordinate to another. As such, a mathematical transformation may be encoded in a matrix. Transformations herein may be “homographies” that map coordinates in one plane to another plane (e.g., wherein a plane may represent a surface or 2D data). A mathematical transformation according to the present invention may be configured to convert a position of a playing field, as captured in, and with respect to, an image of the playing field, into a real-world 2D position on the playing field and/or a real-world 3D position on or above the playing field. A mathematical transformation of the present invention may, for example, be represented by a 2×2, 2×3, 3×2, or 3×3 matrix.

As used herein, “segmenting” or “segmentation” may refer to a computer-vision-related process of detecting, identifying, assigning information to, and/or classifying one or more areas, objects, features, regions, points, and/or lines that are depicted in one or more images. Segmentation may include semantic segmentation, instance segmentation and/or panoptic segmentation.

As used herein, “classifying” or “classification” may refer to a process of identifying some class of area, object, feature, region, point, and/or line to which a segmented part of an image relates. For example, in the present invention, long thin segmented parts of an image may be classified as field lines, and/or more specifically, e.g., as a goal line. Classification may be achieved using one or more neural networks (e.g., trained using data labelled with classes). Other classification techniques or algorithms may be used, as are known in the art, for example, neural network procedures, Frequentist procedures, Bayesian procedures, linear classifiers, support vector machines, quadratic classifiers, or decision trees. In some embodiments, classification operations are separate to segmentation operations, whereas in other embodiments, segmentation may include classification, at least to some extent, and/or segmentation and classification may not be separable (e.g., in the latter example, “segmentation” or “classification” may refer to both processes).

Examples herein may relate the sport or game known as “soccer”, “association football”, or “football”, however, it will be recognized that this is not limiting to the scope of the invention herein, and the invention may relate to or include any number of sports, games, activities, and/or lines, markers, athletes, and/or balls (or similar) thereof. For example, sports may include other versions of football (e.g., American, Gaelic, Australian rules, etc.), baseball, basketball, cricket, rugby, racket sports (e.g., tennis, badminton, squash, table tennis, etc.), bowling, hockey (field, ice, etc.), ultimate frisbee, etc.

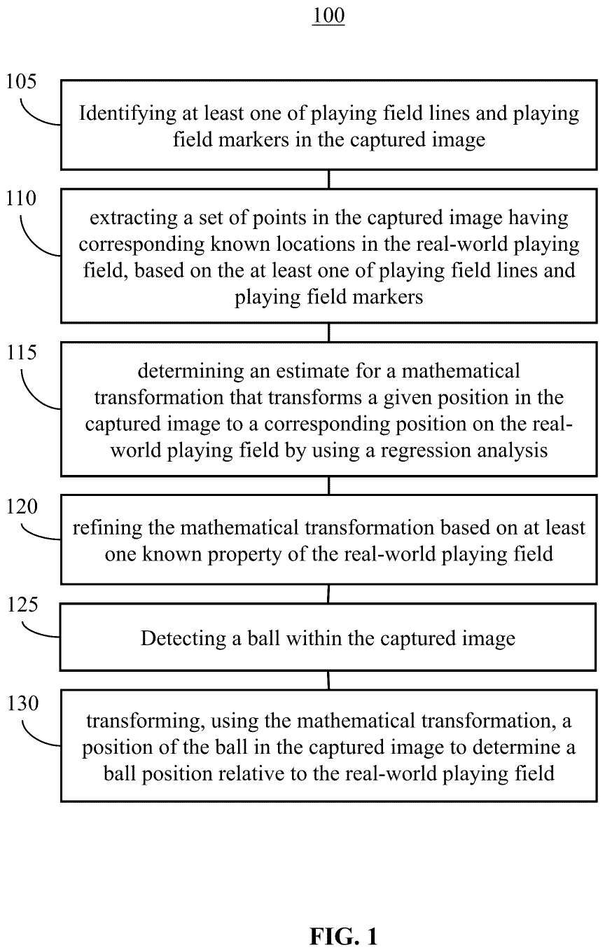

FIG. 1 shows a flowchart 100 for determining a ball position with respect to a real-world playing field according to some embodiments of the invention. The ball position may be found from a captured image (or images) of the ball in the real-world playing field. Images may be captured by one or more imaging devices (e.g., a camera). Video footage or captured images of a real-world playing field may be subject to one or more unknown parameters, for example, an unknown perspective, magnification, angle, distance, distortion, lens, etc. It may thus be difficult to determine the positions (e.g. in real-world terms) of elements, such as balls, from video footage or images thereof.

In operation 105, at least one of playing field lines and playing field markers may be identified in the captured image. The identifying of field lines and/or playing field markers may be carried out using a first neural network.

In some embodiments, identifying at least one of playing field lines and playing field markers in the captured image involves segmenting at least one of playing field lines and playing field markers in the captured image; and/or classifying the at least one of segmented playing field lines and segmented playing field markers in the captured image. Segmenting and classifying may be carried out by the same or a separate neural network (e.g., the first neural network may refer to one or more neural networks).

In some embodiments, prior to segmentation, one or more pre-processes may be run on a captured image. The pre-process(es) may be for increasing an accuracy or effectiveness of segmentation of field lines and/or markers. Pre-processing may include one or more image editing or manipulation operations or techniques. For example, pre-processing may include threshold detection (e.g., global or local), manipulating (e.g., increasing) contrast, manipulating (e.g., increasing) sharpness, manipulating saturation, adding filters or effects, cropping (e.g., cropping out parts known to not be of a playing field or television overlays), manipulating exposure, manipulating dynamic range, etc. Where more than one pre-processing step is carried out, they may be carried out in a particular order. Pre-processing of the present invention may preferably enhance a difference in color and/or appearance between a line and/or marker and the rest of the playing field.

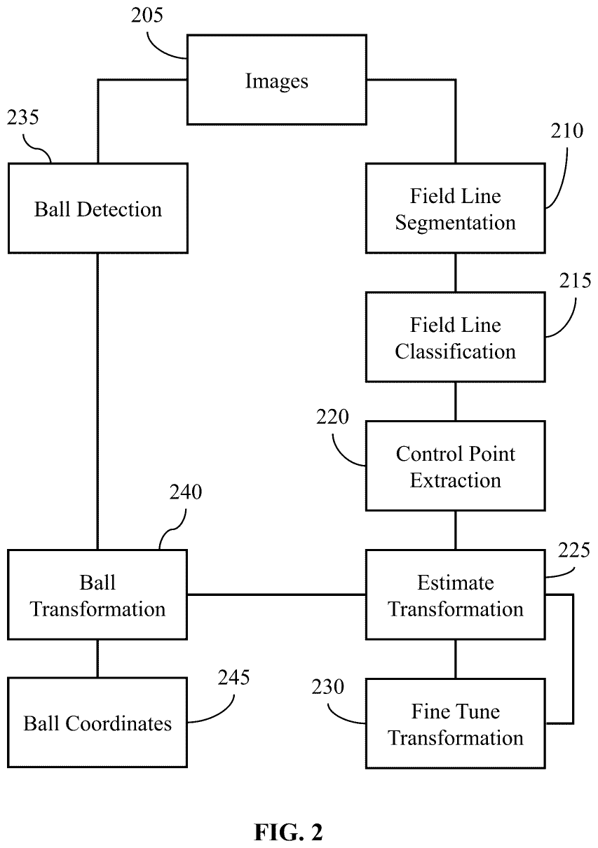

The first neural network may be configured or constructed to segment field lines and/or markers in the captured images (e.g., a segmentation neural network, such as in operation 210 of FIG. 2). The first neural network may receive an input of a captured image and may output one or more data objects (e.g., arrays), which indicate positions of lines and/or markers that are present in the captured image. Positions may be indicated, for example, by indicating a number of positions of points along a line (e.g., including end points).

The first neural network may be trained using video footage or images of sports games. The video footage or images of sports games may be labelled to identify positions of lines and/or markers present in the footage (and possibly the identity of these lines and/or markers, e.g., whether the lines are goal lines, touch lines, etc.). Positions may be indicated using one or more metadata arrays of pixels positions. Attributes of field lines and/or markers, which may, in some embodiments, contribute to the segmentation of field lines and/or markers, may include: field line and/or markers shape (e.g., field lines are ordinarily long with a thin consistent width, and often, but not always, straight, and markers may instead be smaller and circular, e.g., center markers and penalty markers), field line and/or marker color (e.g., a field line and/or marker color is normally distinctive compared to a background color of the playing field, such as white against a green background), etc.

An additional neural network (e.g., a classification neural network, such as in operation 215 of FIG. 2) may be configured or constructed to classify segmented field lines and/or markers. Alternatively the first neural network (e.g., the same neural network as above) may be additionally configured or constructed to classify segmented field lines and/or markers (this neural network may be referred to as a segmentation and classification neural network). In embodiments using an additional neural network, the neural network may receive an input of data objects indicative of positions of lines and/or markers. In embodiments using the same neural network, the neural network may receive an input of a captured image. In each embodiment, the neural network may output data objects indicative of positions of lines and/or markers, wherein said lines and/or markers are identified (e.g., using metadata) as to their class or identity.

In embodiments using an additional neural network, the neural network is trained using one or more data objects which indicate positions of lines and/or markers, wherein the data objects may be labelled to identify lines and/or markers, e.g., whether the lines and/or markers are goal lines, touch lines, penalty markers etc. (and possibly their position in the image). Identities of lines and/or markers may be indicated using one or more metadata objects or strings (e.g., “penalty marker”, “goal line”, etc.). In embodiments using the same neural network, the neural network is trained using footage or images of sports games, wherein the video footage or images of sports games may be labelled to identify lines and/or markers present in the footage, e.g., whether the lines and/or markers are goal lines, touch lines, penalty markers etc. (and possibly their position in the image). Identities of lines and/or markers may be indicated using one or more metadata objects or strings (e.g., “penalty marker”, “goal line”, etc.).

Attributes of field lines and/or markers, which may, in some embodiments, contribute their classification or identification, may include: field line and/or marker shape (e.g., in the context of soccer, if a line is curved, this may narrow it down to being a penalty arc, center circle, or corner arc, and if a line is straight, it may be a half-way line, a touch line, a goal line, a line defining a goal, a line defining a goal area, or a line defining a penalty area, and if it is instead a circular marker, this may narrow it down to being a center marker or penalty marker), field line and/or marker position (e.g., a position of a field line and/or marker relative to other lines and/or markers or other entities in the captured image, such as stands, crowds, goal posts, corner flags, etc.), field line length (e.g., field line lengths may be known in real terms and/or relative to one another), etc.

In some embodiments, classification includes defining which line and/or maker of a certain line and/or marker type the line and/or marker is. For example, it may be sufficient to classify a half-way line as a half-way line, since there is only one halfway line, however, other lines may have to be classified in a form similar to the following: “Top Left Goal Area Line”, “Bottom Right Touch Line”, “Middle Right Penalty Line”, “Half Circle Left”, etc. For example, approximately 30 different categories may be required in the context of soccer.

Segmentation processes may identify potential lines or markers, that are not actually so (e.g., they have been erroneously or incorrectly segmented). As such, classification processes may be configured to identify those lines or markers that are erroneous or incorrect and/or disregard them. Training may train this by providing explicit examples of erroneous markers (e.g., as labelled), and/or otherwise, if lines or markers do not conform to ordinary characteristics, they may be disregarded. Attributes of erroneous field lines and/or markers, which may, in some embodiments, contribute to their classification or identification, may include: an unusual shape, an unusual position, an unusual color, an unusual length, etc.

In operation 110, a set of points in the captured image having corresponding known locations in the real-world playing field may be extracted. The points may be based on the playing field lines and/or playing field markers. For example, the points may be chosen to be points where the position of the points is known with precision in both the captured image (e.g., in terms of pixel coordinates) and in the real world (e.g., in distance coordinates, such as meters or yards). Points may be actual points or virtual points, as defined herein. A marker may, for example, include a penalty marker. An intersection between lines may, for example, include where a center circle crosses a half-way line or where two straight lines defining a penalty box meet at a corner. An intersection between an extrapolated line and an actual line may, for example, include where an extrapolated line defining the edge of a penalty box crosses the half-way line. The location of markers and intersections of actual lines may be more accurate (as they may be extracted directly from visible field lines and/or markers), which could lead to a more accurate transformation, e.g., from operation 115. Whereas intersections involving extrapolated or virtual lines may provide coverage of parts of the playing field without actual lines, which may also lead to a more accurate transformation, e.g., from operation 115. Sets of points may be extracted in operation 110 based on a list of possible points for extraction.

In operation 115, an estimate for a mathematical transformation that transforms a given position in the captured image to a corresponding position on the real-world playing field may be determined.

The estimate for a mathematical transformation or homography may be determined using a regression analysis. The regression analysis can be of a set of points in the captured image and the corresponding known locations in the real-world playing field. In terms normally associated with regression analysis, the set of points in the captured image may be said to be values of an independent variable and the corresponding known locations in the real-world playing field may be said to be values of a dependent variable.

In some embodiments, a mathematical transformation is used to convert a position of a playing field, as captured in, and with respect to, an image of the playing field, in to a real-world 2D position on the playing field and/or a real-world 3D position on or above the playing field. In various embodiments, the mathematical transformation is represented as a matrix, a two-dimensional array, or any combination thereof. The matrix may be two-by-two, two-by-three, three-by-two, or a three-by-three matrix. In some embodiments, the regression analysis is a multivariate robust regression analysis.

In operation 120, the mathematical transformation may be refined based on at least one known property of the real-world playing field. The refining may include transforming a subset of the set of points in the captured image having corresponding known locations in the real-world playing field. This transformed subset of points may be used to assess whether the transformed subset of points conforms with one of the at least one known property of the real-world playing field. “Properties” may be as described elsewhere herein.

In some embodiments, the refining of the mathematical transformation based on at least one known property of the real-world playing field of operation 120 may be based on a subset of the set of points in the captured image having corresponding known locations in the real-world playing field. The corresponding known locations in the real-world playing field of the subset may be defined, with respect to each other, by a known mathematical relationship indicative of the at least one known property of the real-world playing field (e.g., wherein properties may be as described elsewhere herein). By way of one soccer-specific example, a property may include that a ratio of an area of a goal area to an area of a penalty area has a known value of 5/33≈0.15. By way of another example, a property may include that a set of goal posts should be found next to a goal area. Refining may include the operations of: transforming, using the mathematical transformation, each point of the subset of the set of points in the captured image to produce estimated corresponding locations in the real-world playing field, and/or iteratively modifying the mathematical transformation and repeating the transforming step until the estimated corresponding locations in the real-world playing field conform, within a predetermined threshold, to the known mathematical relationship indicative of the known property of the real-world playing field.

Finetuning may be an iterative process, wherein the mathematical process may, for example, be finetuned based on one property, and then another iteration of fine tuning may be carried out with respect to another property.

In some embodiments, finetuning may be based on continuity of lines and markers over time. It may be assessed whether the mathematical transformation of a present captured image is continuous, e.g., within a threshold, when compared to a mathematical transformation corresponding to a previously captured image frame. Alternatively, results (e.g., real-world positions) of the mathematical transformation may be compared to results of a mathematical transformation corresponding to a previously captured image frame, to assess whether, e.g., within a threshold, they are continuous with respect to one another.

In operation 125, a ball may be detected within the captured image. The detection of the ball may be carried out using a second neural network.

In some embodiments, it may be determined whether the detected ball within the captured image is in contact with the playing surface.

The second neural network may receive an input of video footage or images of sports games and may output one or more data objects (e.g., arrays), which indicate a position(s) of a ball within the image(s). It may additionally output whether or not the detected ball is in the air or in contact with the ground/playing surface (e.g., as a Boolean), and/or an estimate for the height or projection of the ball. (e.g., as a number).

The second neural network may be trained using video footage or images of sports games. The video footage or images of sports games may be labelled to identify a position of a ball present in the footage (e.g., using a metadata array identifying a position in terms of pixels). The video footage or images may be those of a broadcast or stream of a sports game. Attributes of a ball, which may, in some embodiments, contribute to its detection by the second neural network, may include: its size (e.g., relative to a playing field or athlete), its shape (e.g., a round shape of a football), its color (e.g., a ball color is normally distinctive compared to the playing field), etc. During operation of the second neural network, inputs of attributes of the ball in use in the captured images may be received; receiving attributes of the ball actually in use may enhance the accuracy of the ball detection by the second neural network. In other embodiments, no input for attributes of the ball may be received, allowing for more automatic operation, increasing adaptability (e.g., if the ball is changed during a game), and reducing human error.

In some embodiments, the second neural network may be additionally configured to recognize whether or not the detected ball is in the air or in contact with the ground/playing surface. In some embodiments, an additional neural network may be configured to recognize whether or not the detected ball is in the air or in contact with the ground/playing surface. In either embodiment this function may be trained using video footage or images of sports games. The video footage or images of sports games may be labelled to identify whether a ball present in the footage is in the air or in contact with the ground (e.g., using a Boolean metadata value), and/or a height of the ball above the ground (e.g., as a floating-point value). The video footage or images of sports games may also be labelled, as before, to identify a position of a ball present in the footage (e.g., using a metadata array identifying a position in terms of pixels). The video footage or images may be those of a broadcast or stream of a sports game. A ball in the footage may be on the ground (in which case, finding its real position may be more straightforward) or may be in the air (in which case, finding its real position may require an alteration or modification to later operations). Given the two-dimensional captured images, it may not be immediately apparent which is the case for any given image. However, there may be attributes specific to airborne balls and attributes specific to ground-level balls, which may, in some embodiments, contribute to recognition of whether or not the detected ball is in the air or in contact with the ground. These may include the direction in which athletes and officials are looking (e.g., if a substantial number of them are looking upwards, the ball is likely airborne), a position of the ball in a captured image (e.g., if the ball is depicted over the stands or a person, it is very likely airborne), whether a ball appears to be in contact with a shadow of the ball (if there is a shadow immediately below the ball, the ball is very likely to be at ground level), whether the ball appears to be a correct size relative to a part of a playing field the ball is depicted over (e.g. if the ball is over a part of the pitch which is relatively far away, but the size of the ball in the image would indicate that the ball is closer than this, the ball is very likely airborne), etc.

In some embodiments, if the ball is determined not to be in contact with the playing surface, the projection of the ball on the field and/or the height of the ball above the field may be estimated, for example, based on the same or another neural network (e.g., trained, at least in part, on images of sports games labelled with a height of a ball above the playing surface), or based on analyzing movement of the ball (e.g., over multiple frames) and/or of the camera (e.g., over multiple frames). For example, a start and end point of the ball being airborne may be found for a number of sequential frames (e.g., based on the output of the second neural network). From this, a total airborne time may be found (e.g., knowing the number of frames captured per second). It may be assumed that, in accordance with equations of motion for a projectile (e.g., SUVAT equations), that the ball moves in a parabola in the real world. The parabola may not appear symmetrical in the captured images, In some embodiments, an assumption that the parabola is symmetrical in the real world can be made In these embodiments, the height may be calculated, for example, as

$$h = \frac{1}{2} gt ( T - t ) ,$$

where h is the height at any given time, g is the rate of gravitational acceleration, Tis the total time the ball is in the air (e.g., as found based on the neural network), and t is time (with 0 being the start of the parabola motion and T being the end). In some embodiments, the transformation (e.g., of operation 115 or 130) is modified to account for the estimated projection and/or height of the ball. Accounting for estimated projection and/or height of the ball can be based on a known real-world or output coordinate of the height above the playing field, and/or a matrix multiplication/transformation may allow for a known value. Based on the amount of time, out of a total, that a ball has been in the air, the known corresponding height of the ball above the playing field may be provided as an input to a transformation step. Other coordinates (e.g., length and breadth/x and y) may be found that comply with this known coordinate (e.g., height/z).

In some embodiments, the captured image is a frame of a sequence of captured images of the ball in the real-world playing field captured over time (e.g., a video). In some embodiments, the ball position relative to the real-world playing field is determined for each frame, and may be based (at least in part) on joint information from all frames. For example, the ball is very likely to be close in position to where the ball was in a previous frame (e.g., assuming a standard refresh rate of the video). Given this, operation 125 may initially look for a ball in a position as found in a previous frame or in a close vicinity thereof. The use of joint information may improve speed and/or accuracy of detecting a ball in an image frame.

In some embodiments, the refining of the mathematical transformation may use joint information. For example, where the mathematical transformation is not within a threshold difference compared to a mathematical transformation calculated with respect to a neighboring frame, by altering the mathematical transformation until it is within a threshold difference compared to the mathematical transformation calculated with respect to a neighboring frame.

In operation 130, a position of the ball in the captured image may be transformed using the mathematical transformation to determine a ball position relative to the real-world playing field. For example, operation 130 may include a vector-matrix multiplication, wherein a vector or array may represent a position of the ball in the present image frame, and a matrix may represent the mathematical transformation. The vector-matrix multiplication may output a vector or array, wherein the output vector or array may represent a ball position relative to the real-world playing field. In some embodiments, the determined ball position relative to the real-world playing field is accurate to within 1 meter.

In some embodiments, operations of flowchart 100 may take place in real time, for example, they may take place during a sporting event of which the captured images are being captured in real time (or live).

FIG. 2 shows a flowchart for determining a ball position with respect to a real-world playing field according to some embodiments of the invention.

In operation 205 images may be received (e.g., as an input). The images may be or have been captured by one or more cameras or imaging devices. The images may be of a real-world playing field. The images may include at least a ball in the real-world playing field. Other features present in the image may include sportspeople or athletes, referees, apparatuses (e.g., goal posts, flags, etc.), field lines, spectators and stands, etc. Operation 205 may include capturing (e.g., by a camera) and/or receiving (e.g., received from an internet video stream) the images. Images of operation 205 may be transferred to operations 210 and/or 235. The images may be subject to one or more unknown parameters, for example, an unknown perspective, magnification, angle, distance, distortion, lens, etc.

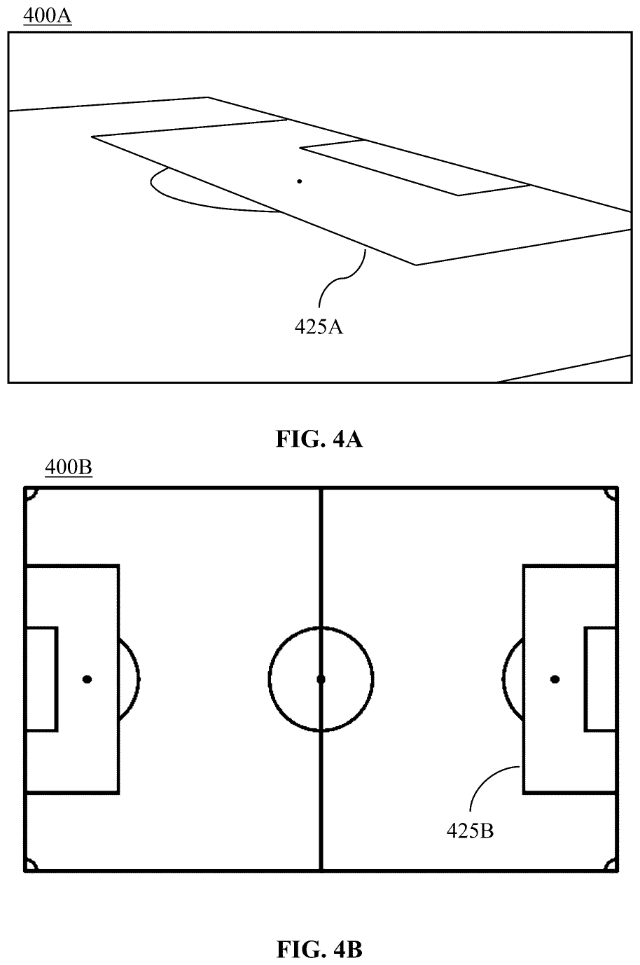

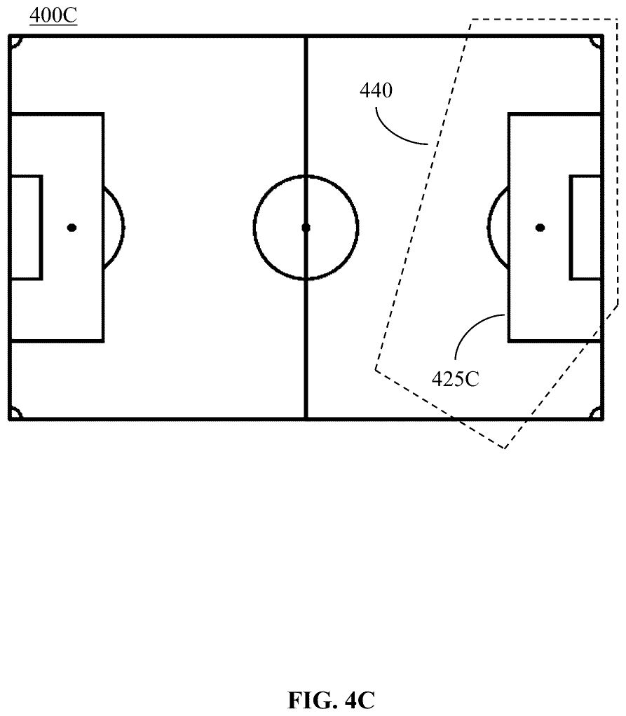

In operation 210 field lines and/or markers may be segmented or identified in or of the image (e.g., as shown in example 400A of FIG. 4A). Identifying features of field lines may, for example, include that they are long and thin and strongly contrasted against their background (e.g., painted white against a green grass background). Operation 215 may be implemented using a neural network. The neural network may be trained in a same or similar manner to the segmentation neural network of FIG. 1. Operation 210 may correspond to operation 105 of FIG. 1.

In operation 215 field lines and/or markers may be classified or identified in or of the image. The lines, e.g., as segmented in operation 210, may be classified or identified as to which line they represent or their location on a standard or regulation playing field. For example, the lines segmented in example 400A of FIG. 4A may be identified as a goal line, two touch lines, the lines defining a penalty area, a penalty spot, and the lines defining a goal area. In some embodiments, the lines' corresponding position on a real-world playing field (e.g., 400B and 400C of FIGS. 4B and 4C, respectively) may be identified. Due, for example, to camera constraints, some lines may not have been properly segmented and/or classified, for example, because they are small, cut off by a camera, mis-segmented, and/or mis-classified. For example, in example 400A of FIG. 4A, a corner arc has not been segmented, where the furthest touch line and the goal line meet. Operation 215 may be implemented using a neural network. The neural network may be trained in a same or similar manner to the classification neural network of FIG. 1. Operation 215 may correspond to operation 105 of FIG. 1.

In some embodiments, operations 210 and 215 may not be separate (e.g., carried out by two neural networks). They may be a single operation, e.g., referred to as field line segmentation, classification, or identification. Both operations 210 and 215 may be implemented using a single neural network. The neural network may be trained in a same or similar manner to the segmentation and classification neural network of FIG. 1.

In operation 220 control points may be extracted or selected, for example, from or based on the segmented and classified field lines of operation 215 (and/or 210). Control points may be points at an intersection between two or more segmented and classified. As such, the location of the control points may be known, both in the image (e.g., 300A, 300B, and 300C), and in the real-world playing field (e.g., 400B and 400C). As such, these points may be used as part of a calculation or estimation of a relationship or mapping between the image and the real-world playing field. Operation 220 may correspond to operation 110 of FIG. 1.

In operation 225 a transformation (or mapping) for transforming or converting a position in a captured image to a corresponding position on the real-world playing field may be estimated or calculated. This estimating or calculating may use a regression analysis of the control points, wherein a first input to the regression analysis is the control points' position in the image, and a second input to the regression analysis is the control points' corresponding position in the real-world playing field. Operation 225 may correspond to operation 115 of FIG. 1.

Optionally, it may be assessed in operation 225 whether the transformation requires fine tuning.

In operation 230 the transformation of operation 225 may be fine-tuned. Fine turning may be as described in operation 120 of FIG. 1; operation 230 may correspond to operation 120 of FIG. 1.

In operation 235 a ball may be detected in the images of operation 205. Operation 235 may be implemented using a neural network. The neural network may be trained in a same or similar manner to the second neural network of FIG. 1. Operation 235 may correspond to operation 125 of FIG. 1.

In operation 240 a position of the ball (in the image), as detected in operation 235, may be transformed into a position of the ball in the real-world playing field. Operation 240 may correspond to operation 130 of FIG. 1.

In operation 245 a position or set of coordinates of the ball in or with respect to the real-world playing field, as calculated by component 240, may be output (e.g., displayed or transferred).

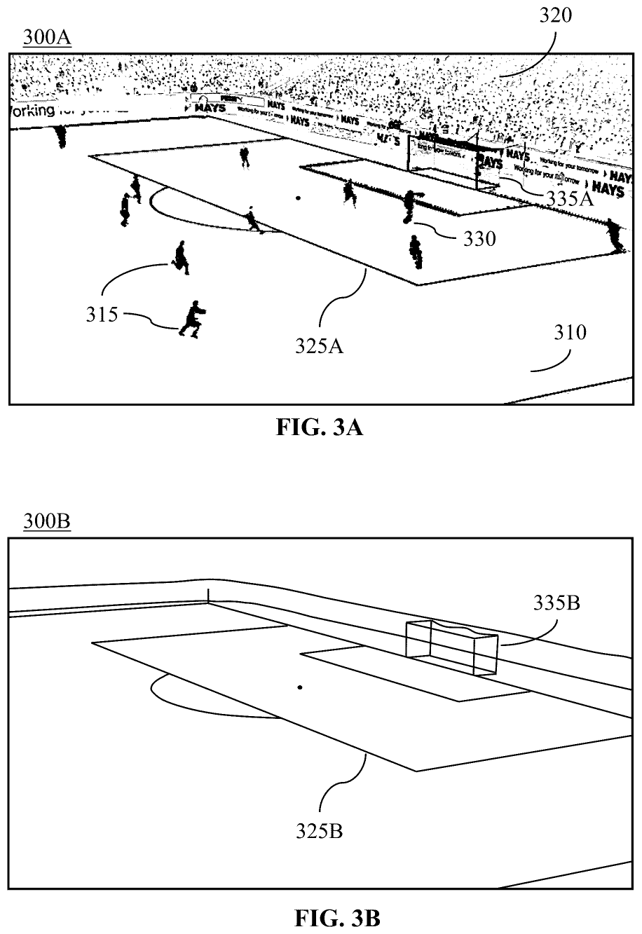

FIG. 3A may represent an example of a captured image 300A of a real-world playing field according to some embodiments of the invention. It will be recognized that, in contrast to the depiction of a captured image 300A herein, a captured image of a real-world playing field may be an image with a larger color gamut than only black and white (as depicted herein), may have any number of resolutions or definitions, including high definition, and/or may include graphical overlays (e.g., depending on the source), such as score overlays, information overlays, and/or branding overlays. The captured image 300A may include depictions of a sports playing surface 310, sportspeople or athletes 315, stands/bleachers/crowds 320, playing field lines and/or markers 325A, a ball 330, and/or one or more goals or other apparatuses 335A. Captured image 300A may correspond to images 205 of FIG. 2 and/or an input captured image to operation 105 of FIG. 1.

FIG. 3B may represent a view 300B of a number of lines and/or markers that may be recognized or segmented in a captured image of a real-world playing field according to some embodiments of the invention. The recognized lines may include playing field lines and/or markers 325B, and may include other lines (e.g., erroneous lines) that may be recognized, e.g. lines depicting stands, flags, goals, etc. 335B. View 300B may visualize an output of a segmentation step (e.g., of operation 210 of FIG. 2 or part of operation 105 of FIG. 1).

FIG. 4A may represent a view 400A of a number of playing field lines and/or markers 425A that may have been segmented and/or classified from a captured image (e.g., 300A). Erroneously segmented entities, stands, flags, goals, etc. may have been disregarded or removed, or otherwise are not depicted. View 400A may visualize an output of a classification step (e.g., except without classes or identities being indicated) (e.g., relating operation 215 of FIG. 2 or part of operation 105 of FIG. 1).

FIG. 4B may represent a top-down view 400B of known locations, dimensions, properties, etc. of a real-world playing field and/or field lines and/or markers 425B thereof. View 400B may be a visualization of knowledge/information of a real-world playing field used during control point extraction (e.g., relating to operation 220 of FIG. 2 or operation 110 of FIG. 1) or during transformation fine tuning (e.g., relating to operation 230 of FIG. 2 or operation 120 of FIG. 1).

FIG. 4C may represent a top-down view 400C of known locations of field lines and/or markers 425C in a real-world playing field, wherein locations which correspond to those captured in a captured image (e.g., 400A) are indicated by a dashed line 440 (e.g., they may fall within the dashed line). For example, 400C may be the view of 400B, wherein the corresponding portions of 400A have been graphically indicated. View 400C may visually represent, at least in part, the function of a mathematical transformation as described herein (e.g., in operation 225 of FIG. 2 or operation 115 of FIG. 1).

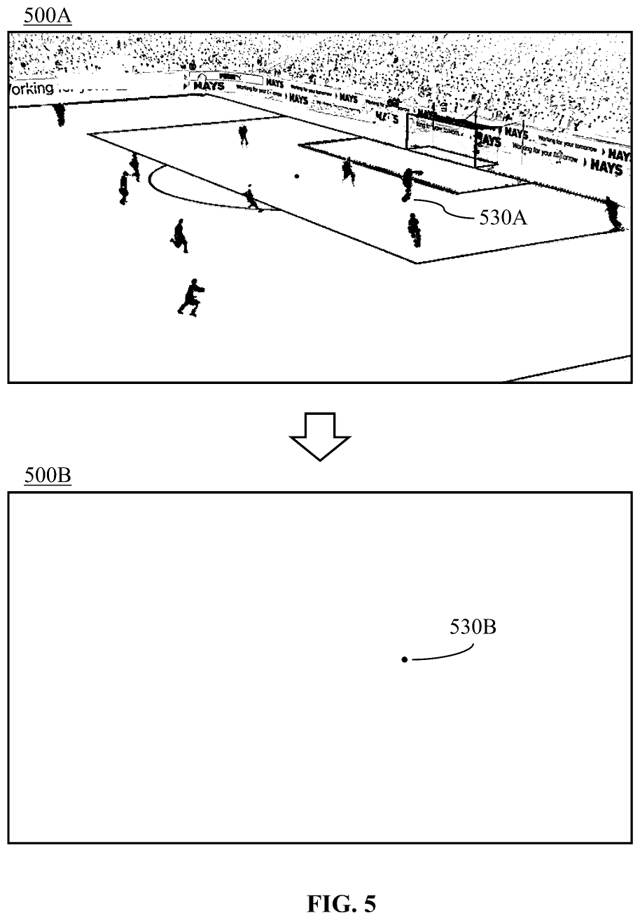

FIG. 5 shows the extraction of a position of a ball in a captured image, wherein 500A may represent a view of a captured image and 500B may be a representation of the location of a ball which is extracted from the captured image. FIG. 5 may visually represent the function of operation 235 of FIG. 2 or operation 125 of FIG. 1.

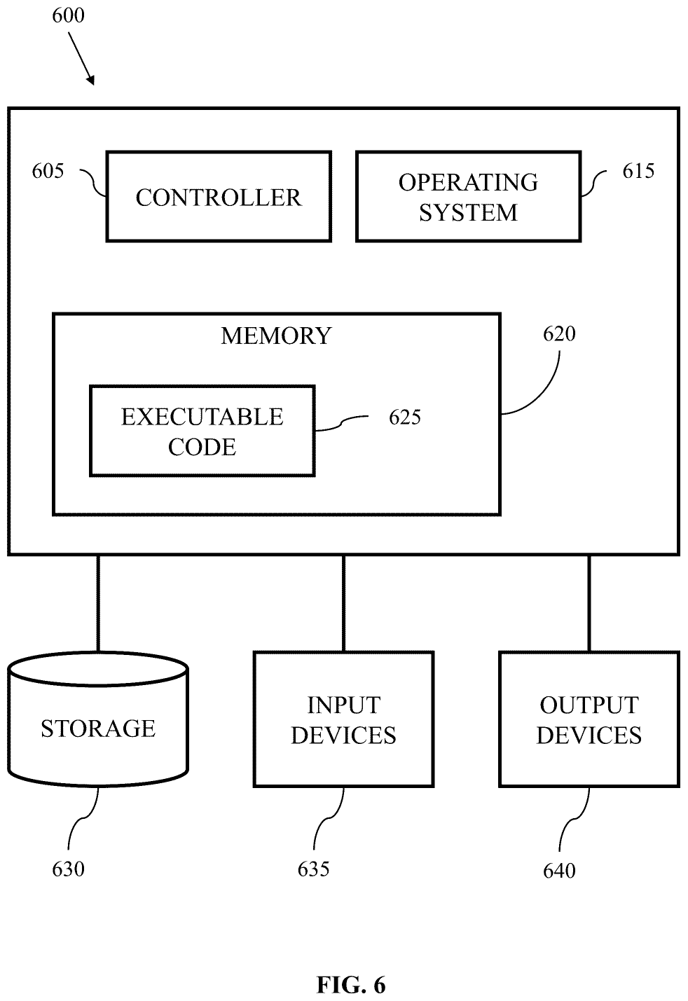

FIG. 6 shows a block diagram of an exemplary computing device which may be used with embodiments of the present invention. Computing device 600 may include a controller or computer processor 605 that may be, for example, a central processing unit processor (CPU), a chip or any suitable computing device, an operating system 615, a memory 620, a storage 630, input devices 635 and output devices 640 such as a computer display or monitor displaying for example a computer desktop system.

Operating system 615 may be, or may include code to perform tasks involving coordination, scheduling, arbitration, or managing operation of computing device 600, for example, scheduling execution of programs. Memory 620 may be or may include, for example, a Random Access Memory (RAM), a read only memory (ROM), a Flash memory, a volatile or non-volatile memory, or other suitable memory units or storage units. At least a portion of Memory 620 may include data storage housed online on the cloud. Memory 620 may be or may include a plurality of different memory units. Memory 620 may store, for example, instructions (e.g., code 625) to carry out methods as disclosed herein, for example, embodiments associated with FIGS. 1-5. Memory 620 may use a datastore, such as a database.

Executable code 625 may be any application, program, process, task, or script. Executable code 625 may be executed by controller 605, possibly under control of operating system 615. For example, executable code 625 may be, or may execute, one or more applications performing methods as disclosed herein, such as determining a ball position with respect to a real-world playing field. In some embodiments, more than one computing device 600 or components of device 600 may be used. One or more processor(s) 605 may be configured to carry out embodiments of the present invention by, for example, executing software or code.

Storage 630 may be or may include, for example, a hard disk drive, a solid-state drive, a compact disk (CD) drive, a universal serial bus (USB) device or other suitable removable and/or fixed storage unit. Data described herein may be stored in a storage 630 and may be loaded from storage 630 into a memory 620 where it may be processed by controller 605. Storage 630 may include cloud storage.

Input devices 635 may be or may include a mouse, a keyboard, a touch screen or pad or any suitable input device or combination of devices. Output devices 640 may include one or more displays, speakers, virtual reality headsets, and/or any other suitable output devices or combination of output devices. Any applicable input/output (I/O) devices may be connected to computing device 600, for example, a wired or wireless network interface card (NIC), a modem, printer, a universal serial bus (USB) device or external hard drive may be included in input devices 635 and/or output devices 640.

Embodiments of the invention may include one or more article(s) (e.g., memory 620 or storage 630) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Computing device 600 may additionally comprise a communication unit for communicating, transferring, transmitting, and/or receiving data to, from, or between another computing device (e.g., one similar to device 600), and/or a neural network.

Systems and methods of the present invention may improve existing ball location technology. For example, by improving accuracy, speed, and/or efficiency, and/or achieving real-time processing.

Embodiments of the present invention may be capable of delivering an accuracy of, by way of example, more than 90% of tests determining a ball position with respect to a real-world playing field within an error threshold of 1 meter. Such an accuracy may be preferable for some implementations of the present invention.

Embodiments may improve computer vision technology by providing hybrid methods and systems incorporating elements of artificial intelligence (AI) as well as classical computer vision. Based, at least in part, on using knowledge of playing field dimensions to fine tune mathematical transformations, embodiments herein may provide for accurately and efficiently locating elements, such as sports balls, on recorded images of the playing field. Embodiments herein may be more accurate than existing methods.

Embodiments herein may be applied to applications involving gambling, sports analytics, sports coaching, research, gaming, virtual reality, and others. For example, in gambling, bets may be made including conditions concerning a position of a ball at a future point in time. It may be desirable in such scenarios to locate the ball at any given time, quickly and accurately. By way of another example, sports analytics and coaching may be enhanced by more in-depth, precise, or accurate knowledge about the position of a ball in real-world terms, e.g., during certain events during a game. By way of another example, if a ball is located accurately, virtual realty systems may be able to render the ball in that location to a viewer, even if the viewer is viewing the system from a different perspective or point of view.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

The invention claimed is:

1. A method for determining a ball position with respect to a real-world playing field, from a captured image of the ball in the real-world playing field, the method comprising:
identifying, using a first neural network, at least one of playing field lines and playing field markers in the captured image;
extracting a set of points in the captured image having corresponding known locations in the real-world playing field, based on the at least one of playing field lines and playing field markers;
determining an estimate for a mathematical transformation that transforms a given position in the captured image to a corresponding position on the real-world playing field by using a regression analysis, wherein the regression analysis is of a set of points in the captured image and the corresponding known locations in the real-world playing field;
refining the mathematical transformation based on at least one known property of the real-world playing field, the refining comprising: transforming a subset of the set of points in the captured image having corresponding known locations in the real-world playing field, to assess whether the transformed subset of points conforms with one of the at least one known property of the real-world playing field;
detecting, using a second neural network, a ball within the captured image;
determining, using the second neural network, if the ball within the captured image is in contact with surface of the playing field; and
transforming, using the mathematical transformation, a position of the ball in the captured image to determine a ball position relative to the real-world playing field.

2. The method of claim 1, wherein refining the mathematical transformation based on at least one known property of the real-world playing field is based on a subset of the set of points in the captured image having corresponding known locations in the real-world playing field, the corresponding known locations in the real-world playing field of the subset being defined, with respect to each other, by a known mathematical relationship indicative of the at least one known property of the real-world playing field, and comprises:
transforming, using the mathematical transformation, each point of the subset of the set of points in the captured image to produce estimated corresponding locations in the real-world playing field, and
iteratively modifying the mathematical transformation and repeating the transforming step until the estimated corresponding locations in the real-world playing field conform, within a predetermined threshold, to the known mathematical relationship indicative of the known property of the real-world playing field.

3. The method of claim 1, wherein identifying at least one of playing field lines and playing field markers in the captured image comprises:
segmenting at least one of playing field lines and playing field markers in the captured image; and
classifying the at least one of segmented playing field lines and segmented playing field markers in the captured image.

4. (canceled)

5. The method of claim 1, if the ball is determined not to be in contact with the playing surface, further comprising:
estimating the projection of the ball on the playing field; and
modifying the transformation to account for the estimated projection of the ball.

6. The method of claim 1, wherein the captured image is a frame of a sequence of captured images of the ball in the real-world playing field captured over time, and wherein the ball position relative to the real-world playing field is determined for each frame is based on joint information from all frames.

7. The method of claim 6, wherein refining the mathematical transformation further comprises:
where the mathematical transformation is not within a threshold difference compared to a mathematical transformation calculated with respect to a neighboring frame, altering the mathematical transformation until it is within a threshold difference compared to the mathematical transformation calculated with respect to a neighboring frame.

8. The method of claim 1, wherein the mathematical transformation is represented as a matrix.

9. The method of claim 1, wherein the regression analysis is a multivariate robust regression analysis.

10. The method of claim 1, wherein the determined ball position relative to the real-world playing field is accurate to within 1 meter.

11. A system for determining a ball position with respect to a real-world playing field, from a captured image of the ball in the real-world playing field, the system comprising:
at least one camera to:
capture images of the ball in the real-world playing field;
at least one processor configured to:
identify, using a first neural network, at least one of playing field lines and playing field markers in the captured image;
extract a set of points in the captured image having corresponding known locations in the real-world playing field, based on the at least one of playing field lines and playing field markers;
determine an estimate for a mathematical transformation that transforms a given position in the captured image to a corresponding position on the real-world playing field by using a regression analysis, wherein the regression analysis is of a set of points in the captured image and the corresponding known locations in the real-world playing field;
refine the mathematical transformation based on at least one known property of the real-world playing field, the at least one processor configured to: transform a subset of the set of points in the captured image having corresponding known locations in the real-world playing field, to assess whether the transformed subset of points conforms with one of the at least one known property of the real-world playing field;
detect, using a second neural network, a ball within the captured image;
determine, using the second neural network, if the ball within the captured image is in contact with surface of the playing field; and
transform, using the mathematical transformation, a position of the ball in the captured image to determine a ball position relative to the real-world playing field.

12. The system of claim 11, wherein the at least one processor configured to refine the mathematical transformation based on at least one known property of the real-world playing field is based on a subset of the set of points in the captured image having corresponding known locations in the real-world playing field, the corresponding known locations in the real-world playing field of the subset being defined, with respect to each other, by a known mathematical relationship indicative of the at least one known property of the real-world playing field, and wherein the at least one processor is configured to:
transform, using the mathematical transformation, each point of the subset of the set of points in the captured image to produce estimated corresponding locations in the real-world playing field, and
iteratively modify the mathematical transformation and repeating the transforming step until the estimated corresponding locations in the real-world playing field conform, within a predetermined threshold, to the known mathematical relationship indicative of the known property of the real-world playing field.

13. The system of claim 11, wherein to identify, using a first neural network, playing field lines in the captured image, the at least one processor is configured to:
segment playing field lines in the captured image; and
classify the segmented playing field lines in the captured image.

14. (canceled)

15. The system of claim 11, wherein, if the ball is determined not to be in contact with the playing surface, the at least one processor is further configured to:
estimate the height of the ball; and
project the ball location on the field the transformation to account for the estimated height of the ball.

16. The system of claim 11, wherein the at least one camera is configured to:
capture a sequence of images of the ball in the real-world playing field over time; and
wherein the determination, by the at least one processor, of the ball position relative to the real-world playing field takes place for each frame based on using joint information from all frames.

17. The system of claim 16, wherein to refine the mathematical transformation, the at least one processor is further configured to:
where the mathematical transformation is not within a threshold difference compared to a mathematical transformation calculated with respect to a neighboring frame, alter the mathematical transformation until it is within a threshold difference compared to the mathematical transformation calculated with respect to a neighboring frame.

18. The system of claim 11, wherein the mathematical transformation is stored in computer memory as a matrix.

19. The system of claim 11, wherein the regression analysis is a multivariate robust regression analysis.

20. The system of claim 11, wherein the determined ball position relative to the real-world playing field is accurate to within 1 meter.

21. The method of claim 1, sending the determined ball position to a virtual realty system in order to render the ball in that location to a viewer, for a plurality of different perspectives or point of views.

22. The system of claim 11, further comprising a virtual realty system to receive the determined ball position and render the ball in that location to a viewer, for a plurality of different perspectives or point of views.
